(19) United States
(12) Patent Application Publication
(10) Pub. No.: US 2018/0096307 A1
(43) Pub. Date: Apr. 5, 2018

(54) ADAPTIVE, HYBRID REASONING DECISION SUPPORT SYSTEM FOR PERSONNEL HIRING AND INTER-CONNECTED BUSINESS STRATEGIC EVOLUTION

(71) Applicants: MASSACHUSETTS, UNIVERSITY OF, Boston, MA (US); ARETISOFT, LLC, Melrose, MA (US)

(72) Inventors: Paul J. Fortier, Portsmouth, RI (US); Theophano Mitsa, Melrose, MA (US)

(21) Appl. No.: 15/717,096

(22) Filed: Sep. 27, 2017

Related U.S. Application Data
(60) Provisional application No. 62/402,112, filed on Sep. 30, 2016.

(51) Int. Cl. G06Q 10/10; G06N 5/04

(52) U.S. Cl. CPC G06Q 10/1053; G06N 5/04

(57) ABSTRACT

A method of providing decision support for personnel hiring, the method comprises receiving a list of one or more mandatory hiring criteria and one or more desirable hiring criteria for a position, retrieving a profile of a job candidate from a candidate case base, computing a suitability of the job candidate for the position by determining if the job candidate profile includes all mandatory hiring criteria, and responsive to the job candidate profile including all mandatory hiring criteria, computing a suitability ranking of the job candidate based on a degree of similarity of the one or more mandatory hiring criteria and one or more desirable hiring criteria to qualifications in the job candidate profile, and ranking the job candidate against other job candidates based on the suitability ranking of the job candidate and suitability rankings of the other job candidates.

### CROSS-REFERENCE TO RELATED APPLICATIONS

This application claims priority under 35 U.S.C. § 119(e) to U.S. Provisional patent Application Ser. No. 62/402,112, titled “ADAPTIVE, HYBRID REASONING DECISION SUPPORT SYSTEM FOR PERSONNEL HIRING AND INTER-CONNECTED BUSINESS STRATEGIC EVOLUTION,” filed Sep. 30, 2016, which is incorporated by reference herein in its entirety for all purposes.

### TECHNICAL FIELD

Aspects and implementations of the present disclosure are directed generally to an adaptive, hybrid reasoning decision support system for personnel hiring and inter-connected business strategic evolution.

### BACKGROUND

As described in L. Breiman's classic paper (Breiman, Statistical Modeling: The Two Cultures 2001), there are two cultures in statistical modeling—(a) A culture, known as data modeling, that assumes that data is created from a model; examples include linear regression and logistic regression; and (b) Another culture, known as algorithmic modeling, that assumes no model in the creation of the data. In this culture, the data creation mechanism is treated as an unknown and the focus is on an algorithmic approach to solve the various data problems, such as prediction and interpretation. Examples of this approach include decision trees and artificial intelligence techniques, such as neural networks. Model-based hiring systems for the evaluation of candidates during the interview process are presented in (Larsen, 2015) and (Taylor, 2017). Another approach, (Doka, 2014), is based on TOPSIS (Technique for Order of Preference by Similarity to Ideal Solution), which is a multi-criteria decision making method developed by Hwang and Yoon (Hwang, 1981). Its main idea is to employ geometric distances to order alternatives according to their distances from the ideal and negative ideal solution. It assumes linearity and independence of criteria.

### SUMMARY

An important factor for the success of every company is to have the best available talent, particularly at its strategic positions. Disclosed herein are aspects and embodiments of a hybrid, adaptive decision support system that can be used to fill company positions and also monitor how hiring is aligned with company objectives, expressed in the form of business metrics.

In this disclosure, the term hiring practices is meant to have the following three dimensions: (a) hiring activity, such as number of positions filled or number of positions still open; (b) hiring criteria; i.e., job qualifications such as a Ph.D. degree, or four years of experience with the Java language; and (c) skill questions, which are questions of a questionnaire used to evaluate a candidate during interview time.

Through the use of one or more intelligent agents, embodiments of the system and method disclosed herein implement a correlation of hiring practices and business metrics in an ongoing loop. There are two types of business metrics considered in this disclosure: key performance indicators (KPIs) and employee review ratings. The performance indicators may be computed (a) at the individual employee level, such as number of sales, (b) at an aggregate level, such as number of defects of a specific product released by the company. This way, hiring practices may be constantly evaluated using as a yardstick whether they resulted in the hiring of employees that are instrumental in achieving the company's strategic goals.

Alternatively, the importance of hiring criteria is evaluated post-hire by introducing noise in the hiring criteria and seeing which employees (previous candidates) are left out. If candidates that are currently top tier employees are left out by the “noising” of the hiring criterion, then this is important criterion to keep as is. “Noising” refers to the introduction of noise to the value of the hiring criterion.

This decision support system (DSS) has a user-friendly interface, and its purpose is to assist hiring managers of a company find a best match for a current job opening considering either external applicants or candidates that are present company employees. The hiring company can be a global company with a variety of employee skills and levels of skills. The system uses a hybrid approach that combines a rule engine with case-based reasoning. The rule engine is used to specify the job qualifications (hiring criteria), while a case-based approach is used to specify the external applicant profiles and the current employee profiles.

Aspects and embodiments of a hybrid system disclosed herein combine an expert system with case-based reasoning. The system is also adaptive, because, as new employee cases are added, the system learns from them. The system is differentiated from previous approaches for at least the following reasons:
In contrast to data modeling approaches, we do not assume that there exists a hireability model from which hirable employee data are created. This frees us from the need to make assumptions about the data, such as linearity or independence of attributes, to be able to fit a certain model.
The lack of assumptions is also an advantage in comparison with TOPSIS-based techniques.
In contrast to algorithmic modeling techniques that take a black box approach, our approach is a white-box, fully transparent approach.
The evaluation of hiring practices is performed post-hire and the goal of this evaluation is to assess how these practices (in the form of the three dimensions) help the implementation of the company's strategic goals. This is in contrast to approaches, such as in (Larsen, 2005) and (Taylor, 2017) where only the dimension of interview questions is considered and the evaluation of this dimension happens pre-hire during the candidate's interview. This is also in contrast to (Samad), where the criteria mentioned for the scoring of candidates (academic, personality traits) are simply provided by the hiring manager and not validated in any way.

Aspects and embodiments of the disclosed system have at least the following advantages over existing employee selection systems:
Real time access to the power of individual use cases: Employee profile data are not consumed by algorithmic or data models, which encapsulate all data-based knowledge in a single model. In our system, the user has access to raw employee profile data to aid in his decision making
Superior suitability for detection of imbalanced classes, such as stellar (top 2%) of employees: In modeling approaches, whether data or algorithmic, detection of rare classes suffers from the class imbalance problem. Because of the scarcity of data for these rare classes, their representation inside models is overshadowed by the well represented classes.
A transparent, white-box approach and continuous monitoring of business evolution through human-interpretable insights: These insights are in the form of strengthened rules and most useful, most cited use cases, etc. This is in contrast to data and algorithmic modeling approaches that digest new business information in non-human interpretable ways, such as tweaking model parameter values or strengthening neural network weights.
Enablement of new knowledge discovery: The sequential presentation of a plurality of use cases for the solving of a new problem may lead to the discovery of new knowledge that was never considered before.
Alignment with business strategy: Following the recruitment of candidates, business metrics (KPIs and employee review ratings) are correlated with the three dimensions of the hiring practices, in order to determine whether these practices helped with the implementation of the business' strategy and resulted in the hiring of high quality employees.

In accordance with an aspect of the present invention, there is provided a method of providing decision support for personnel hiring. The method comprises receiving a list of one or more mandatory hiring criteria and one or more desirable hiring criteria for a position, retrieving a profile of a job candidate from a candidate case base, computing a suitability of the job candidate for the position by determining if the job candidate profile includes all mandatory hiring criteria, and responsive to the job candidate profile including all mandatory hiring criteria, computing a suitability ranking of the job candidate based on a degree of similarity of the one or more mandatory hiring criteria and one or more desirable hiring criteria to qualifications in the job candidate profile, and ranking the job candidate against other job candidates based on the suitability ranking of the job candidate and suitability rankings of the other job candidates.

In some embodiments, the suitability of the job candidate for the position is calculated in accordance with the formula

$$SSC = \frac{{\sum }_{i = 1}^{N} {w}_{i} {s}_{i}}{{\sum }_{i = 1}^{N} {w}_{i}}$$

where:
i=1, . . . N are variables for N hiring criteria,
sᵢ is, for the i^{th} hiring criterion, a similarity of actual hiring criterion and corresponding employee qualification, and
wᵢ is a weight for the similarity of i^{th} variable.

In some embodiments, sᵢ for a hiring criterion is calculated in accordance with the formula

sᵢ=1−(jrₘᵢₙ−eqᵢ)/range(jrᵢ)

where:

jrᵢ is the i^{th} hiring criterion,

jrₘᵢₙ is a minimum acceptable value for jrᵢ, and

eqᵢ is an employee qualification corresponding to jrᵢ.

In some embodiments, the method further comprises computing correlations of hiring criteria with business metrics.

In some embodiments, the method further comprises assessing a change in mandatory and/or desired hiring criteria specified in hiring requests over time.

In some embodiments, the method further comprises assessing importance of hiring criteria by changing a minimum acceptable value for a hiring criteria and determining a change in a number of high value employees that would have been selected for hiring if the hiring criteria included the changed minimum acceptable value.

In some embodiments, the method further comprises assessing importance of hiring criterion as indicated by its correlation with a business metric. Business metrics may include, for example, a key performance indicator or an employee review rating. A strong positive correlation may indicate that this is an important criterion to keep.

In some embodiments, the method further comprises performing a skill questions assessment based on how candidate scores, degree of difficulty, and number of questions that correlate with employee review ratings.

In some embodiments, the method further comprises assessing importance of hiring criteria by reclassifying a hiring criterion from desirable to mandatory and determining a change in a number of high value employees that would have been selected for hiring if the hiring criteria was mandatory.

In accordance with another aspect, there is provided a decision support system for personnel hiring. The system comprises an employee case base including profiles of current employees, an external candidate case base including profiles of external job applicants, a rule engine including rules specifying hiring criteria for at least one position, and an inference engine configured to search the employee case base and the external case base and to identify and present profiles of candidates having attributes showing correlations with attributes specified by a hiring manager for a position.

In some embodiments, the profiles of the current employees include data regarding the qualifications of the current employees and the profiles of the external job applicants include data regarding the qualifications of the external job applicants.

In some embodiments, the inference engine is further configured to search the employee case base and the external case base and to compute similarity of a candidate with an employee paradigm, the employee paradigm including an employee profile representing an ideal solution to a hiring need.

In some embodiments, the system further comprises a hiring search case base including at least one hiring case representing hiring search criteria for a position. Hiring cases in the hiring search case base may include an indication of whether the hiring case is a hiring case for a strategic position. Hiring cases in the hiring search case base may include an indication of whether the hiring case is a hiring case for an unfilled position or for a filled position.

In some embodiments, the system further comprises a user interface configured to receive a search query including a job description and to present a list of one or more hiring cases from the hiring search case base associated with the job description, the list generated by a hiring case search engine of the system. The user interface may be further configured to receive an indication from a user whether a hiring case from the list of one or more hiring cases is useful to the user. The hiring search case base may be configured to increase a usefulness rating of the hiring case responsive to the user providing the indication that the hiring case is useful. The hiring case search engine may be configured to present the list of one or more hiring cases in the user interface ranked according to one or more of the usefulness ratings of the respective one or more hiring cases or creation dates of the respective one or more hiring cases.

In some embodiments, the system further comprises a user interface configured to receive a search query including a job description and a job attribute and to present a list of one or more hiring cases from the hiring search case base associated with the job description and job attribute, the list generated by a hiring case search engine of the system.

In some embodiments, the system further comprises an aggregate hiring search case base including all hiring criteria that have been specified in previous hiring searches for at least one job description. Each hiring criterion in the aggregate hiring search case base may have an associated usefulness rating. Each skill question in the aggregate hiring search case base may have an associated usefulness rating. The system may further comprise a user interface configured to receive an indication of a job description from a user and to display all hiring criteria in the aggregate hiring search case base associated with the job description to the user, the hiring criteria ordered according to one or more of the usefulness ratings of the respective hiring criteria or creation dates of the respective hiring criteria. The system may further comprise a user interface configured to receive an indication of a plurality of job descriptions from a user and to display all hiring criteria in the aggregate hiring search case base associated with the plurality of job descriptions to the user, the hiring criteria ordered according to one or more of the usefulness ratings of the respective hiring criteria or creation dates of the respective hiring criteria.

In some embodiments, the system further comprises an intelligent agent including autonomous software configured to search for suitable candidates in the employee case base and/or external candidate case base as long as a hiring search remains open.

In some embodiments, the rules specifying the hiring criteria for the at least one position include a list of one or more mandatory qualifications and one or more preferable, but non-mandatory, qualifications.

In some embodiments, the system further comprises a user interface configured to present a user with a menu of job descriptions, receive a selection of a job description from the user, present the user with a listing of qualifications, and receive an indication from the user of which qualifications in the list of qualifications are mandatory and which qualifications in the list of qualifications are optional for a hiring search.

In some embodiments, the system further comprises functionality to provide for the user to add a job description to the menu of job descriptions.

In some embodiments, the system further comprises functionality to provide for the user to add a qualification to the list of qualifications.

The system may be configured to perform any of the methods disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates part of an ontologically expressed employee profile;

FIG. 2 illustrates a user interface for a hiring search;

FIG. 3 illustrates a hiring search saved ontologically;

FIG. 4 illustrates an aggregate hiring case;

FIG. 5 is a flow diagram for determining candidate hireability;

FIG. 6 illustrates the membership function for fuzzy set “cold temperature”;

FIG. 7 illustrates the membership function for fuzzy set “technical adeptness”;

FIG. 8 illustrates the membership function for fuzzy set “customer satisfaction”; and

FIG. 9 illustrates a computer system upon which aspects of methods disclosed herein may be performed.

### DETAILED DESCRIPTION

Aspects and implementations disclosed herein are not limited to the details of construction and the arrangement of components set forth in the following description or illustrated in the drawings. Aspects and implementations disclosed herein are capable of being practiced or of being carried out in various ways.

A salient feature of aspects and embodiments of the systems and methods disclosed herein is ontological categorization of hiring criteria, external job application qualifications, and employee qualifications. This ontological categorization allows for a uniform, structured language to express the hiring needs and workforce attributes of a company on a global scale.

As the term is used herein an ontology is very similar to a taxonomy. The main difference between an ontology and a taxonomy is that a taxonomy only allows classes/subclasses, while an ontology also allows relationships to be defined. So for a Job Description example:

The class Computer Engineer has the following subclasses: Computer Security Engineer, Applications Engineer, Network Engineer, Data Engineer, etc. This can be expressed using a taxonomy or an ontology.

Now let us say that we conducted a hiring search on Apr. 10, 2017 for an Applications Engineer, which resulted into the hiring of Jeff Smith. This cannot be expressed in a taxonomy. In a hiring ontology we can define the relationship “result of hiring search” and have “4-10-2017 Applications Engineer Hiring Search” be connected with Jeff Smith, via the relationship “result of hiring search.”

The disclosed system can be used stand-alone to aid with employee selection or in conjunction with a model-based system. Although the system is described for hireability applications, it can find use in other applications (particularly with imbalanced classes). Aspects and embodiments of the disclosed decision support system for personnel hiring can be incorporated into a larger human resources suite, for example, ADP or other human resources management software suites.

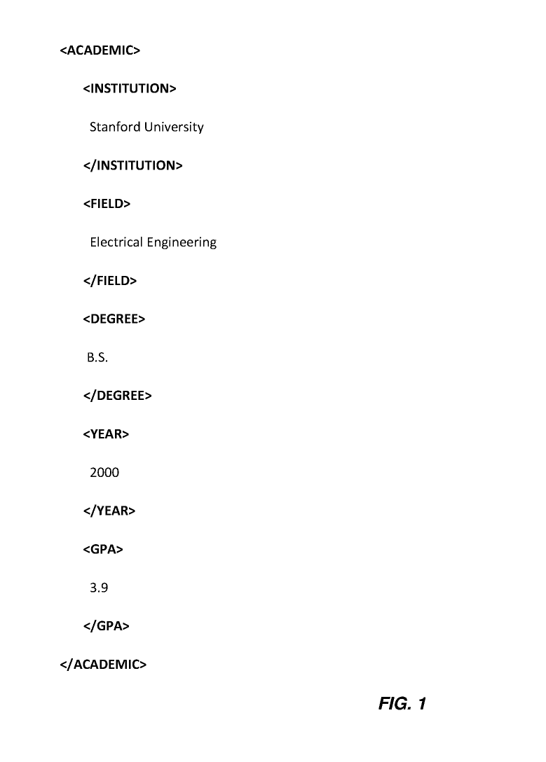

Components of the disclosed system may include the following:
Employee case base (ECB): This case base consists of current employee profiles, in all company locations, with their attributes expressed in an ontological manner Part of an ontologically expressed employee profile is shown in FIG. 1.
External candidate case base (EXCB): This case base consists of external job applicants with their attributes/qualifications expressed in an ontological manner
Rule engine (RE) and rule trees (RT): The rule engine performs two tasks: (a) presentation of hiring rules to the user; and (b) organization of the rules (hiring criteria) in tree structures. For example, this can be an fp-tree (most frequent rules close to the root of the tree).
Inference Engine: At run time, the inference engine searches the employee case base (ECB) and the external case base (EXCB) and presents candidate profiles, whose attributes show similarity/correlation to the ones specified by the hiring manager. Besides computing similarity with the hiring criteria, the user can compute similarity of a candidate (external or internal) with employee paradigms. Employee paradigms are employee profiles that represent the ideal solution to our present hiring need. In simple terms, we would like to have more like these employees.
Hiring search case base (HSBC): Following the end of the candidate search by the hiring manager, his hiring search criteria, specified in the rule engine, become a hiring case and are saved in a case base called the hiring search case base.
Aggregate hiring search case base (AHSBC): For each job description, the aggregate hiring case contains all hiring criteria that have been specified in previous hiring searches, ordered according to their usefulness.
Intelligent Agent(s) (bot(s)): One or more autonomous pieces of software will be employed to perform various monitoring tasks, such as searching for suitable candidates in ECB and EXCB, as long as a hiring search remains open.

One example of a method employing an embodiment of the disclosed system for performing a hiring search is as follows:

Let us assume that the user is looking for a Data Scientist with the following qualifications:

A. Must-Have Qualifications
Ph.D. in Computer Science.
Over 4 years industrial experience.
Excellent knowledge of Python programming language.
Excellent knowledge of Java programming language.

B. Nice-to-Have Qualifications
Experience with Hadoop.
Experience with Spark.
Experience with natural language processing.

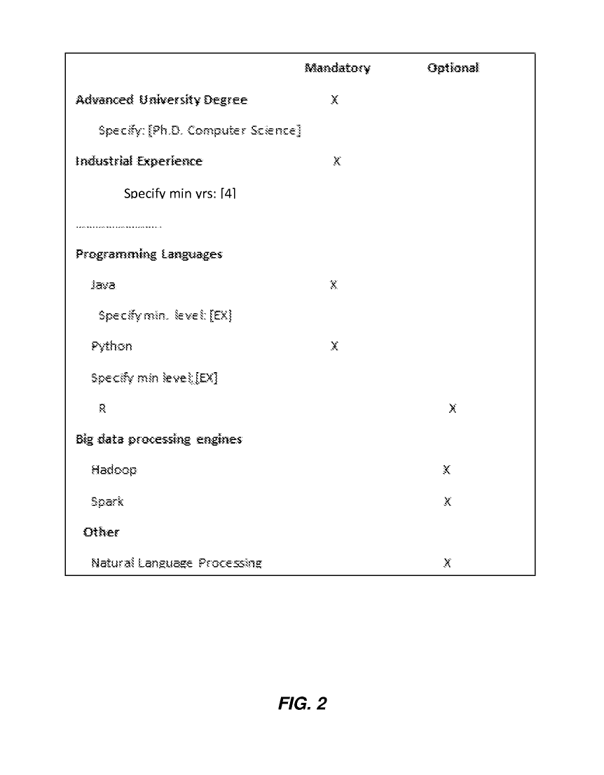

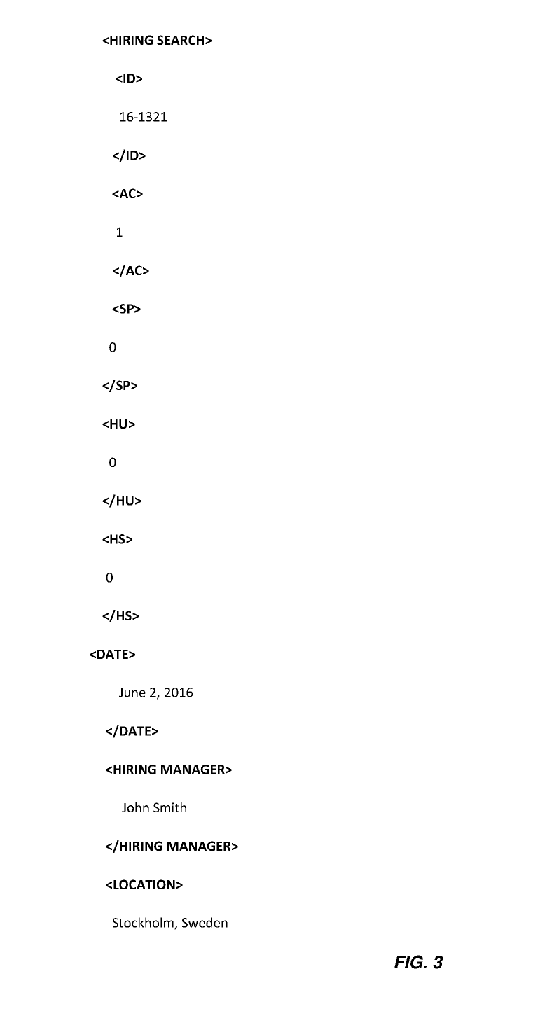

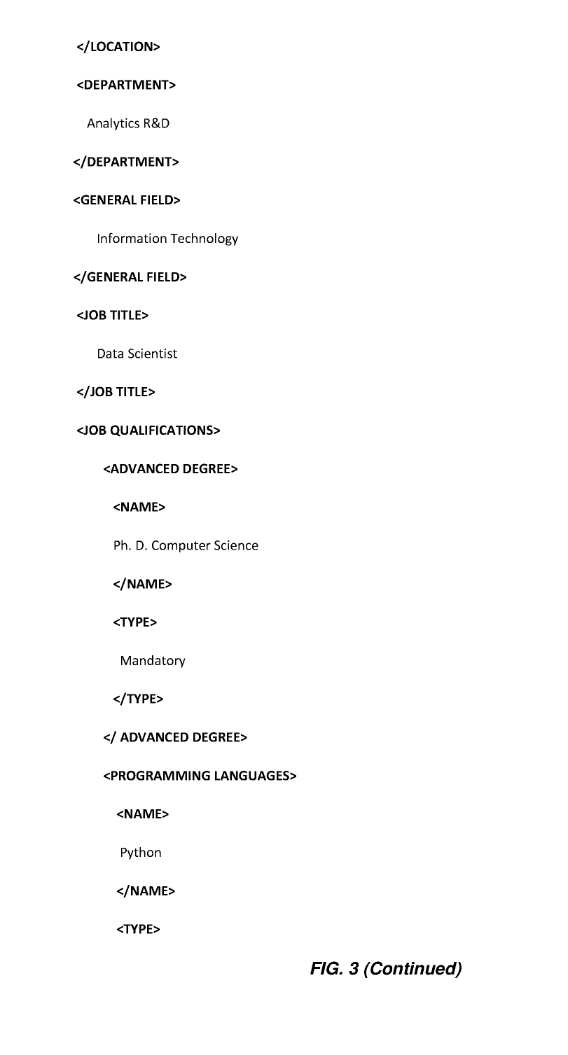

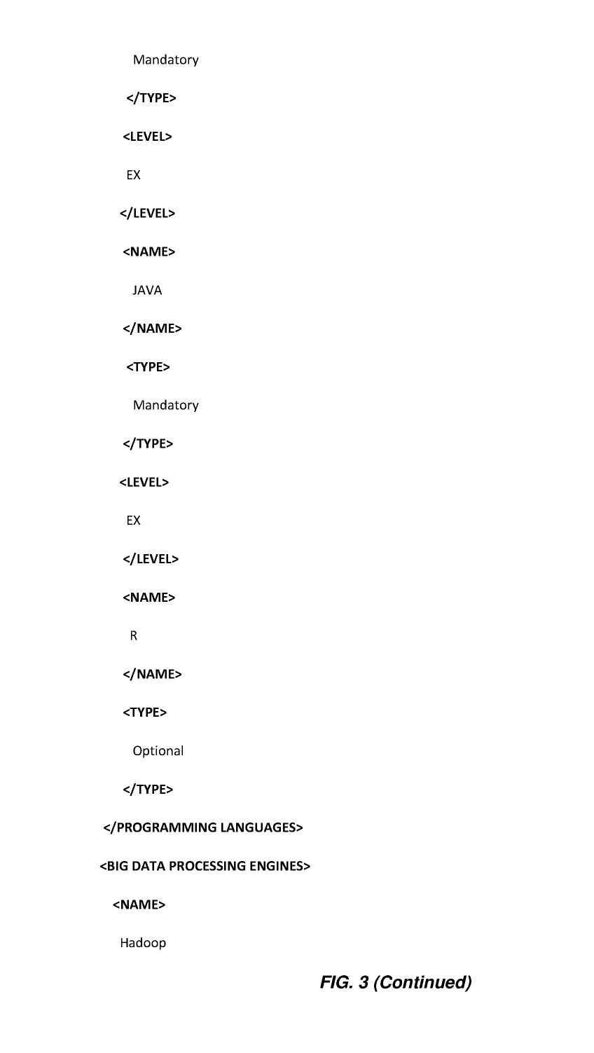

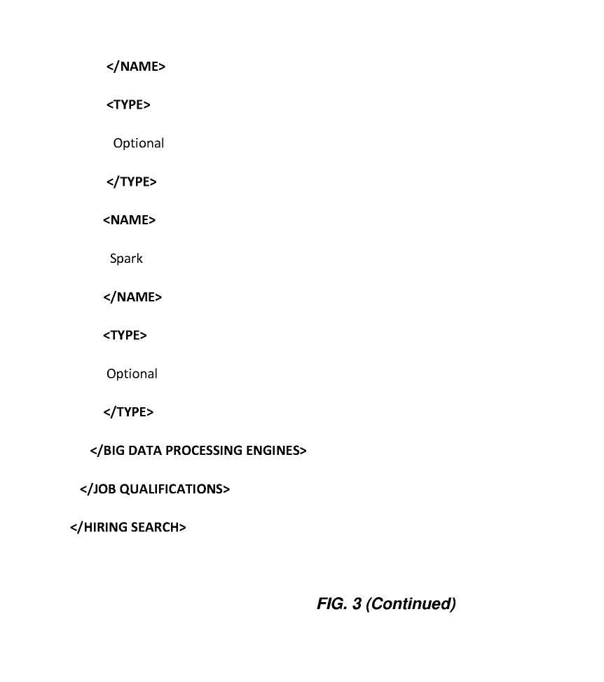

In the user interface of the DSS system and in the ontologically structured Job Description menu, the user chooses first Information Technology and under that chooses Data Scientist. Note that if a job description with the specified title does not exist, the user can add this job description to the appropriate menu. It is the Rule Engine's task now to present the appropriate Job Qualifications, where the user selects the appropriate items and indicates whether they are mandatory or optional (nice to have's). An example of how the relevant areas of the user interface would look like is shown in FIG. 2. If an item does not appear in the menu, as the Experience with natural language processing, it is specified in the Other field and the Rule Engine adds it in the job qualifications menu of the Data Scientist job. When the user exits the hiring search user interface, the hiring search is saved in an ontological format (XML for example) in HSBC. An example is shown in FIG. 3. A few things to note in this figure:
The rule engine assigns an ID and records the date, location and name of the hiring manager.
The XML element SP is used to indicate that this is not a strategic position (this is indicated by the hiring manager).
The XML element AC is used to indicate that this is still an open hiring search. As long as the position is not filled, the search case 16-1321 remains active in HSBC, by setting AC to 1. If the position is filled, the value of the AC is set to 0. Given that employee profiles are continuously updated with information, such as performance reviews, absences, etc., an intelligent agent monitors and searches ECB for a potential match, as long as AC(16-1321) is set to 1.

So as we see above, storing of the hiring case in a database (casebase), allows the continued search (by a bot) for an appropriate candidate, as long as the position remains open.

Another potential use of the stored hiring search is that it can serve as a paradigm for another DSS user. Specifically, another hiring manager can search for a Data Scientist, by simply entering the key words Data Scientist and nothing else. In this case, the system presents, to the manager, cases from HSCB, that have the same ontological name Data Scientist. The hiring manager can mark as useful hiring cases that match his criteria and eventually select a hiring case that suits him best. Every time a hiring case is found useful, the value of an XML element, called Hu, in its stored description, is incremented by 1. Similarly, every time a hiring case is selected to be used in a new hiring search, the corresponding XML element, Hs, in its stored description, is incremented by 1.

Usefulness and selection affect the order previous hiring cases are presented to the user, when he simply enters a job description (and no qualifications). First to be presented are the cases with a high selection value followed by cases with a high usefulness value. The selected cases are ordered temporally, with the most recent presented first and similarly, the useful cases are ordered and presented. The basis of the temporal ordering is the date XML element of the hiring search. Finally, every time a hiring search is found useful, a type of credit is attributed to the creator of the hiring search, by increasing the value of an XML element, OC (short for ontology contributor) in his employee profile. This way, the system keeps track and rewards the hiring personnel that contribute to the enrichment and updating of the ontological environment.

In addition to the methods mentioned above, the hiring manager can perform a hiring search by entering an ontologically correct name tag, such as Data Scientist, and partially filling out the job attributes, such as Python Language Required. Then the user can request to look at hiring searches with the same name tag in HSCB. He can choose to have past hiring searches presented in a temporal order (the most recent first) or according to their usefulness rating (as specified in the previous section). If he finds a rule he considers interesting in the other hiring search cases, such as Experience with Hadoop he can mark this rule as useful, which automatically adds this rule in his hiring search.

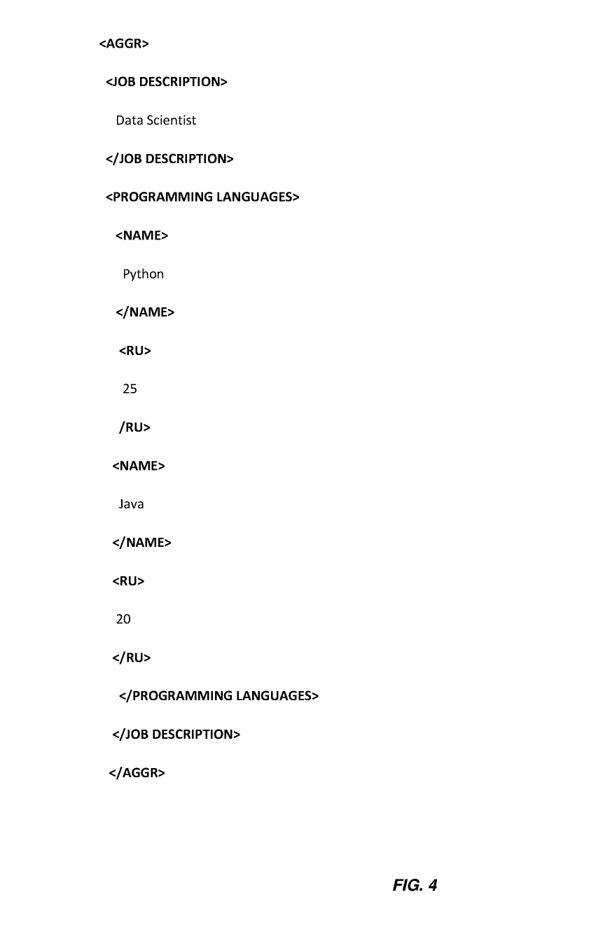

Let us now define the aggregate hiring case and see how it is connected to rule usefulness. For each job description, i.e., Data Scientist, all rules (hiring criteria) that have been specified in hiring searches with this name are put in the aggregate hiring case, where each rule (hiring criterion) has a usefulness element, Ru, associated with it. Within the aggregate hiring case, rules can be ordered in a descending order of their usefulness. Alternatively, rules can be ordered in a descending temporal order (with the most recent found useful or entered in the system first). At any time, the user can request to view the aggregate hiring case for the job he is interested in hiring for, either in a descending usefulness or temporal order. An example of an aggregate hiring case is shown in FIG. 4. Besides offering help in performing a hiring search, aggregate cases, along with the rule usefulness information, offer a synoptic view of how business needs are evolving as it pertains to the job qualifications of various positions.

Aggregation can be done at a semantic level higher than the individual hiring search, for example at the Information Technology (IT) field level. Aggregating all hiring searches that fall under a higher semantic level (e.g. IT), can offer higher level insights between skill sets and business evolution. For example, if aggregation of Computer Engineers, Testing Engineers, Data Scientists, and Database Engineers hiring searches (at the IT field ontological level), in a cloud application development company, shows an increase of the requirement for 6-sigma certification and this is correlated with a decrease in product defects, this is a significant insight.

Having entered the hiring search in one of the ways specified above, the inference engine searches the employee profile case base (ECB) and the external candidate case base (EXCB) for suitable candidates. Let us consider the following example:

The hiring manager is looking to fill a Data Scientist position, where the job qualifications are as follows:

### Mandatory

Requirement 1: B.S. or M.Sc. in Computer Science or Data Science.
Requirement 2: At least 2 years of experience with the Python Language.
Requirement 3: At least 2 years of experience with machine learning techniques.
Requirement 4: If this is a current employee, a performance rating of 2 and above in the last two years. (Assume that the highest possible rating is 1 and the lowest 4).

### Optional

Experience with natural language processing.
Experience with R.
Experience with Spark.

Let us now consider the following fictitious internal candidate, J.J. Doe:
M.S. in Data Science.
Three years experience with the Python Language.
Two years experience with machine learning projects.
Performance rating of 2 in past year, performance rating of 1 this year.
Experience with R.

and see how the inference engine can compute the suitability of this employee profile for the above hiring search.

The first thing to be considered is whether all the mandatory job qualifications are present in the candidate's profile. There are five mandatory qualifications (the performance rating requirement is expanded into two, because it refers to two years). If any of them is not present in the candidate's profile, then the inference engine rejects the candidate and does not proceed any further with his profile. The flow of the candidate's qualifications through the hiring requirements decision tree and the corresponding results are shown in FIG. 5.

J.J. Doe's qualifications satisfy all the hiring search criteria, so we proceed to the computation of the suitability score for J.J. Doe. Given that the job qualifications are expressed using variables of mixed types, the suitability/similarity, SSC, of the candidate's profile can be computed as:

$$SSC = \frac{{\sum }_{i = 1}^{N} {w}_{i} {s}_{i}}{{\sum }_{i = 1}^{N} {w}_{i}}$$

where:
i=1, . . . N are the variables for the N hiring criteria,
sᵢ is, for the i^{th} hiring criterion, the similarity of actual hiring criterion jrᵢ and corresponding employee qualification eqᵢ
wᵢ is the weight for the similarity of i^{th} variable.

The formula for SSC above is similar to the Gower index proposed in (Gower, 1971) for mixed type data, but there are significant differences in the computation of the weights and similarities sᵢ. It is important to note also that this just one way similarity can be computed.

Let us now compute the individual components of SSC:
First, let us assign a weight of 1 to all mandatory hiring criteria and a weight of 0.5 to all optional criteria. This assignment is heuristic, and is done, simply to indicate that the mandatory hiring criteria are more important than the optional ones. Note that the user of the DSS will be permitted to assign any values to wᵢ and sᵢ, to best represent the importance of each variable.
For i=1, we have the nominal variable university degree and we multiply its similarity sᵢ with a weight value of 2. The reason is that J.J. Doe has a M.S. in Data Science. If that was a B.S. degree, we would assign a weight of value 1 (to indicate the fact that a M.S. is of higher value than a B.S. degree).
For i=2, we have the interval variable years of experience with the Python language. In Gower's formula, and for interval type data, s is computed as follows:

s=1−|jrᵢ−eqᵢ|/range(jrᵢ)
We will modify this formula to capture the nature of our variables.
Specifically, we remove the absolute value and replace jrᵢ with jrₘᵢₙ:

$${s}_{2} = 1 - \frac{2 - 3}{3 - 2} = 2$$

Here, we assume that the maximum number years of Python language experience among the job candidates is three years.
Similarly, for i=3, we have the interval variable years of experience with machine learning. Here, J.J. has the minimum years of experience required, so:

$${s}_{3} = 1 - \frac{2 - 2}{3 - 2} = 1$$

Here, we also assume that the maximum number of years of machine learning experience among the job candidates is three years.
For i=4, we have the ordinal variable performance rating. Gower's formula does not account for ordinal variables. Here, to compute s, we can use a variant of the formula proposed by (Podani, 1999). Specifically, Podani's formula is:

s=1−|jrᵢ−eqᵢ|/(max(jrⁱ)−min(jrᵢ)
where the one we will use is:

s=1−(eqᵢ−jrₘᵢₙ)/range(jrᵢ)
such that a performance rating of 1 (highest possible) will produce a higher similarity than a performance rating of 2. Note that jrₘᵢₙ here is 2.

The above formulas for similarity s are tailored to the specific hiring requirements on page 14. For different hiring requirements, the formulas could be slightly modified. For example, if there was a hiring requirement that specified a maximum, such as maximum 4 years since obtaining a certification, then the formula would be:

s=1−(eqᵢ−jrₘₐₓ)/range(jrᵢ)

Returning to our current use case, in the case of J.J. Doe and for the past year

$$s = 1 - \frac{2 - 2}{1} = 1$$

For the current year:

$$s = 1 - \frac{1 - 2}{1} = 2$$

Finally, regarding the optional hiring criteria, J.J. Doe satisfies only “Experience with R,” which we will weigh with 0.5. The optional hiring criteria he does not satisfy will be assigned a value of 0.

Therefore, the overall similarity score of J.J. Doe is:

$$SSC = \frac{0.5 ⋆ 1 + 1 ⋆ 2 + 1 ⋆ 2 + 1 ⋆ 1 + 1 ⋆ \frac{1 + 2}{2}}{4.5} = \frac{7}{4.5}$$

The first terms in the products of the equation above for SSC are the corresponding weights for each computed similarity and the denominator is the sum of these weights. For the experience criterion, the two similarities (for first and second year) were averaged.

The same way we can compute the similarity score of the other candidates and the hiring manager can decide to invite any number with the highest similarity scores. Besides the hiring criteria, the hiring manager can find suitable candidates by comparing with employee paradigms from the employee case base. These employee profiles satisfy all or some of the hiring criteria and in addition are top performers. As an example, let us assume that in the aforementioned hiring search, there are five candidates with higher scores than J.J., and J.J. is not in the short list for an interview. However, the hiring manager, searching the employee case base, finds an employee paradigm with a M.S. degree in Data Science from the same school as J.J. In the profile of the employee paradigm, it is noted that he was a top contributor in one of the important machine learning projects of the company, which he attributed to his education's emphasis on hands-on experience with machine learning projects. As machine learning is an important part of the new job, the hiring manager decides that J.J. Doe's education is an important reason to include him in the short list.

Following the selection of the candidates based on the hiring criteria, there can be an optional second step of skill assessment questions during interview time. These questions would constitute the third dimension of the company's hiring practice. In the next sections, we will discuss how the three dimensions of the hiring practices will be correlated with business metrics (KPIs and employee review ratings). This correlation will be performed by one or more intelligent agents.

### 1. Correlation of Hiring Practices and Business Metrics:

### 1.1 Correlation of Hiring Activity and Key Performance Indicators

The activity tag in the hiring cases and aggregate hiring cases, saved in the hiring case base, can be used to answer many important questions related to business performance. One way to measure business performance is through the key performance indicators (KPIs) as proposed in (Marr, 2012). Examples of these performance indicators include:
Financial performance indicators, such as net profit and return on investment (ROI).
Customer-related, such as customer complaints and customer retention rate.
Market-related, such as market growth rate and market share.
Operational performance related, such as time to market, process waste level, quality index and rework level.
Employee related, such as average employee tenure, time to hire, employee churn rate, 360 Feedback score.

Combining the date information with the level of the activity tag (0 or 1), the intelligent agent can measure an important employee-related metric, time to hire. Then the Pearson correlation coefficient can be used to measure correlation between KPIs and the number of activity tags (and/or changes in their level), at an individual and aggregate hiring case level. For example:
many open positions for a long time along the pipeline of a specific product can provide an explanation for a long time-to-market.
changes from closed to open and back to open can be potentially correlated with a low quality index of a product and increased number of customer complaints.
a recent filling of a strategic position in marketing in India can potentially be the cause of the upsurge of market growth in that country.

Let us consider an example. The hiring activity measure is the number of engineers with 6-sigma certification that were hired to work on a product and the business performance metric is the number of defects in the released product. Assuming a linear relationship, the correlation between number of 6-sigma certified engineers and product defects can be computed using the Pearson correlation coefficient. Besides the Pearson correlation coefficient that indicates the strength of the relationship, one can also compute the statistical significance of the correlation. If we can not make the assumption of a linear relationship, the Spearman rank order correlation coefficient can be used instead.

### 1.2 Correlation of Hiring Criteria and Business Metrics

The business metrics that hiring criteria can be correlated with are KPIs, as above, or employee review ratings. Hiring criteria with a strong positive correlation with business metrics are important criteria that help the implementation of the business' strategy. On the other hand, hiring criteria with a low positive or negative correlation with business metrics can be eliminated from the hiring process. Correlation between hiring criteria and business metrics can be computed at the aggregate (e.g. department) or individual employee level. Additionally, it can be computed using either crisp or fuzzy data. Most of the data we encounter in our everyday lives fall in the crisp category, i.e., they are precise numbers, such as Tom's age is 34 years old, or your bank balance is 2000.41. Fuzzy data, on the other hand, are not precise, in the sense there is some ambiguity, in terms of what their values are.

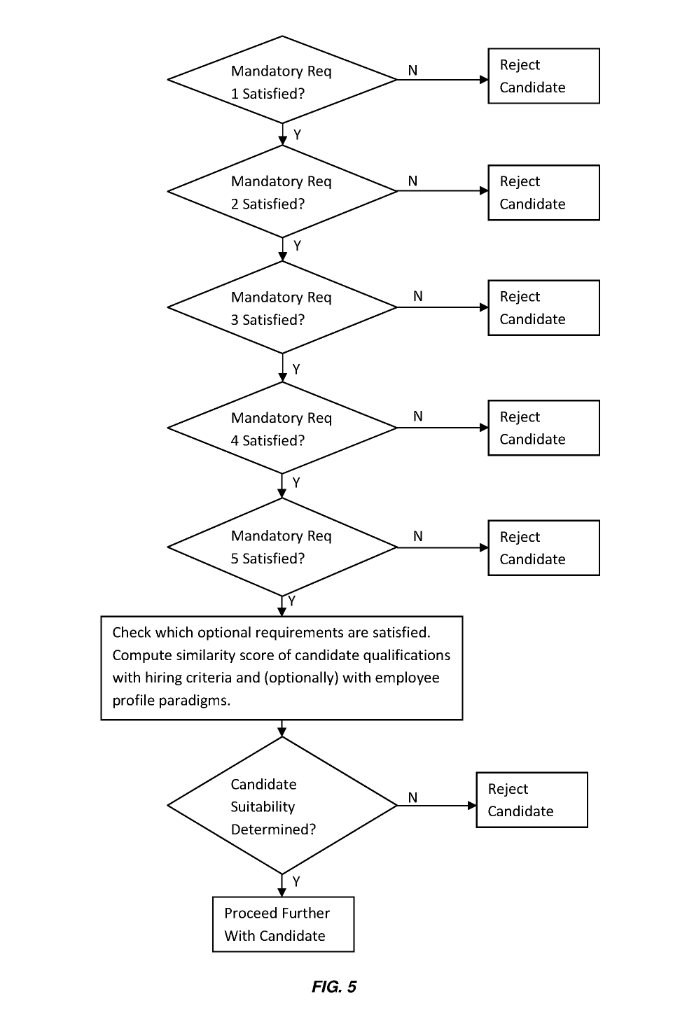

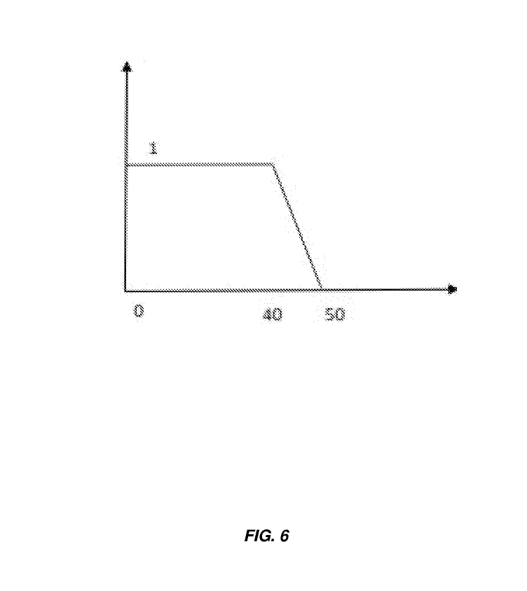

A popular example used to explain fuzzy logic is weather temperature. When we say the temperature is 32 degrees, this is a crisp way of defining the temperature. Instead, we can simply say it is cold, which defines the temperature in a fuzzy way. Now, in this latter case, the temperature is a fuzzy number. A fuzzy set is a set of objects that have a continuum of membership grade (Zadeh, 1965), and therefore each fuzzy set is associated with a membership function. This function is defined in an interval [a,b], with values that range from 0 to 1. FIG. 6 shows the membership function for the fuzzy set “cold temperature”.

In regards to hiring criteria, a crisp one is the average number of years in previous jobs. A fuzzy one is “knowledge of Java language”. Please note that although the discussion here is about “hiring” criteria, it could easily be applied to criteria obtained through training. For example, an employer decides to train his employees in 6-sigma methodology, and, then through correlation with key performance indicators, he can understand their impact on the business.

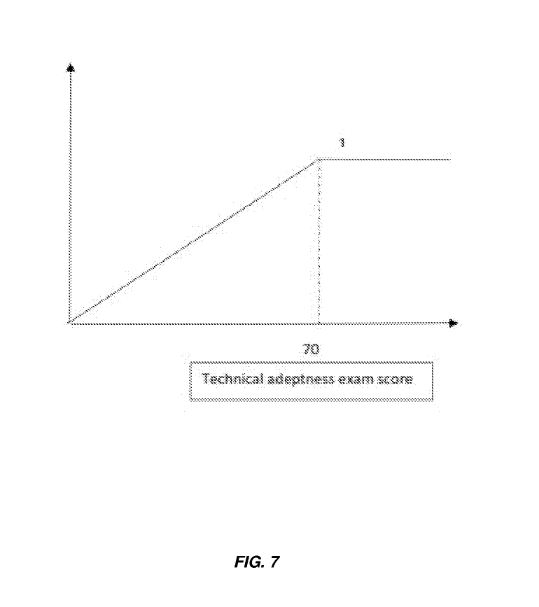

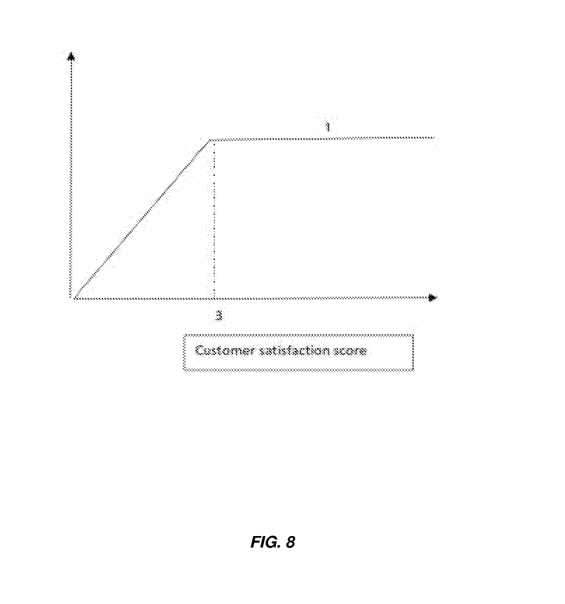

Let us consider the following example, where the correlation coefficient is computed from fuzzy data. A communications company that provides phone/internet/TV service, in order to alleviate its technical department from regular heavy call volumes, hired a number of technically adept people to staff its regular customer service call center. Four months after the hire, the manager wants to see how the fuzzy set “technical adeptness” is correlated with the fuzzy set “customer satisfaction”. FIG. 7 shows the membership function for fuzzy set “technical adeptness” and FIG. 8 shows the membership function for fuzzy set “customer satisfaction”. There are quite a few ways to compute the correlation between two fuzzy sets and this correlation can be itself either crisp or fuzzy (Ni, 2005). In the method proposed by (Chang, 1999), a crisp correlation is computed, using the Pearson correlation coefficient formula, where the data values are replaced by membership grades. For example, let us assume that Table 1, illustrated below, shows the data collected by the technical manager regarding a random sample of customer call center employees. Plugging these data into Excel, and using the membership values as the data values, yields a Pearson correlation coefficient of 0.702.

TABLE 1
Example employee memberships to the fuzzy sets “Technical
Adeptness” and “Customer Satisfaction”.

| Employee | Technical Adeptness | Customer Satisfaction |
|---|---|---|
| Susan | 1 | 1 |
| Tom | 1 | 1 |
| Anna | 0.5 | 1 |
| Laurie | 0.2 | 0.4 |
| Sandra | 0.6 | 0.3 |
| Jack | 0.5 | 0.4 |
| Frank | 0.9 | 1 |

1.3 Correlation of Skill Question Scores with Business Metrics

Skill questions can be asked during the interview phase, and they constitute the third (optional) dimension of hiring practices. Skill questions can vary regarding their number, test subjects, and degree of difficulty. For example, candidates for the position of Data Scientist can be tested in the subjects of statistics and the programming language Python. Here are some example findings that could prove helpful in hiring high quality candidates in the next hiring round:
Correlation of question scores with employee review ratings: Candidates with high scores in statistics questions and average scores in Python questions tend to beget higher review ratings as employees than candidates with average scores in statistics and high scores in Python questions. To indicate this, an intelligent agent could assign a higher usefulness score to statistics questions than Python questions.
Correlation of question's degree of difficulty with employee review ratings: Candidates that get a high score in high-degree-of-difficulty statistics questions tend to get the highest employee ratings. To indicate this, an intelligent agent could assign the highest usefulness score to the most difficult questions (among all statistics questions).
Correlation of number of questions with employee review ratings: Candidates that answer correctly more statistics questions than Python questions tend to get higher employee ratings. To address this, we could include more statistics than Python questions in the next candidate skill test.

### 2. Change Assessment in Hiring and Aggregate Hiring Cases:

Another important question that can be answered through monitoring with an intelligent agent is how hiring criteria change in individual and aggregate hiring cases over time. This can provide valuable insights as to the stability and evolution of various hiring criteria.

Let us work through an example and assume that we have a hiring search for an Applications Engineer at time t1 (APP_ENG(t1)) and another at time t2 (APP_ENG(t2)).

### Criteria of Search APP_ENG(t1):

Criterion A: Usefulness value: 8
Criterion B: Usefulness value: 15
Criterion C: Usefulness value: 10
Criterion D: Usefulness value: 16
Criterion E: Usefulness value 5

Criteria of Search APP_ENG(t2):

Criterion A: Usefulness value: 9
Criterion B: Usefulness value: 22
Criterion C: Usefulness value: 12
Criterion a Usefulness value: 17

The intelligent agent can assess the changes in the hiring criteria in three distinct ways:
Set similarity: Here, the intelligent agent will measure the overlap between the two sets of hiring criteria. Metrics that measure set overlap, such as the Jaccard index (Niwattanakul, 2013) or the Tanimoto distance can be employed (Duda, 2001). Given the following equation for the Jaccard index for sets S1 and S2:

$$J = \frac{\vert S 1 ⋂ S 2 \vert}{\vert S 1 \vert + \vert S 2 \vert - \vert S 1 ⋂ S 2 \vert}$$

the Jaccard index for the example above is:

$$J = \frac{4}{5 + 4 - 4} = \frac{4}{5}$$

because set S1 (APP_ENG(t1)) has 5 hiring criteria, set S2 (APP_ENG(t2)) has 4 hiring criteria, and the two sets share 4 criteria in common (A,B,C,D).
Similarity of hiring criteria usefulness: This can be computed using a correlation measure, such as the Pearson correlation coefficient or a distance measure, such as the Euclidean distance. For the example above, the Euclidean distance of the hiring criteria of the two searches is:

d=\sqrt{d^{A}₂d_{B}²+d_{C}²+d_{D}²}=\sqrt{(8−9)²+(15−22)²+(10−12)²+(16−17)²}
Note that for the E hiring criterion, we do not have a distance component, because it is absent in APP_ENG(t2). This difference, regarding E, is captured in the previous similarity measure (set similarity).
Similarity of ordering of hiring criteria: The similarity in the order of importance of the various hiring criteria (where importance is based on the usefulness value) can be computed using the Spearman rank correlation coefficient.

The values of the Pearson and Spearman correlation coefficient for this example are computed below using the R statistical software. The software also computes statistical significance, and as we see neither of the correlation coefficients is statistically significant.

>s1<-c(8,15,10,16,5)

>s2<-c(9,22,12,7,0)

>cor.test(s1,s2)

Pearson's product-moment correlation:

data: s1 and s2

t=1.3982, df=3, p-value=0.2565

alternative hypothesis: true correlation is not equal to 0

95 percent confidence interval:

−0.5700263 0.9718309

sample estimates:

cor

0.6281424

>cor.test(s1,s2,method=“spearman”)

Spearman's rank correlation rho:

data: s1 and s2

S=12, p-value=0.5167

alternative hypothesis: true rho is not equal to 0

sample estimates:

rho

0.4

An important note here is that, having defined measures of change in hiring criteria, each company/organization can define windows of acceptable change. For example, if criteria for a specific position vary significantly over a short period of time, this could indicate a problem in the following areas:
the requirements for the position are not well understood.
the goals of the position are not clearly defined.

Furthermore, the values of the aforementioned similarity metrics can be correlated with the business metrics discussed in previous sections, to yield insights as to how changes in hiring criteria affect the performance of the company.

### 3. Evaluation of Hiring Criteria Importance:

Following candidate hiring, the importance of hiring criteria can be evaluated with a technique used in random forests (Breiman, 2001), where variable importance is assessed by introducing noise in features and observing which feature's noising up results to the highest increase in the misclassification rate. Here we will not examine misclassification, instead the intelligent agent will examine how noise introduction in a feature results in the exclusion of candidates. Examples of how noise can be introduced by an intelligent agent in the hiring criteria of the aforementioned Data Scientist hiring search are:
Make an optional requirement (such as experience with natural language processing) mandatory. If many candidates, who are currently top tier performers in annual company reviews, are left out, then natural language processing experience is not an important criterion. Alternatively, instead of annual company review performance, we could use as a criterion a business metric directly, such as employees with a high number of sales.
Randomly increase the minimum number of years of experience required for the Python language, and observe which candidates that were selected are now left out. If candidates, who are currently poorly performing employees are left out, then this is an important criterion and the minimum number of years of experience in the Python language should be increased

Aspects and embodiments of the disclosed system can output both entities and actions.

### Entities:

Name(s) of hiring candidates for a hiring search.
Output media: User interface and database.
Hiring search case.
Output media: Saved to the database.
Aggregate hiring search case.
Output media: Saved to the database
Rule (hiring criteria) trees.
Output media: Saved to the database.
Correlations between key performance indicators and number of activity tags set to 0, set to 1, and recently changed from 0 to 1. These activity tags can belong to aggregate hiring cases or individual hiring cases associated with a department, a business location or a specific product.
Output media: User interface and database.
Correlations between hiring criteria and key performance indicators or employee review ratings.
Output media: User interface and database.
Change-assessment indicators of hiring criteria, expressed as similarity, metrics (of set, order, and usefulness value). If a window of normal operation values has been set, it can be indicated that the change assessment values are within the window or fall outside.
Output media: User interface and database.
Correlations between skill questions' scores, degree of difficulty, number and employee review ratings.
Output media: User interface and database.
Usefulness value (vote) of a hiring criterion.
Usefulness value of a skill question or group of skill questions.

### Actions:

Setting the value of the activity tag of a hiring search case to 1, to indicate that the search is closed.
Location: Database
Increasing the usefulness value of a hiring case.
Location: Database
Increasing the usefulness value of a hiring criterion (rule), after (a) it was indicated so by the user, or (b) having the hiring rule appear in a new hiring search or (c) finding the rule important in a post-hire analysis of noise introduction in the hiring criteria, as explained in section 1.3, or finding it is important because of a strong positive correlation with a key performance indicator or employee review rating.
Location: Database.
Selection of candidates for a hiring search.
Monitoring and upgrading of the usefulness of hiring cases.
Monitoring and upgrading of the usefulness of hiring rules.
Creation of aggregate hiring cases.
Correlation of hiring actions with key performance indicators.
Correlation of hiring criteria with key performance indicators or employee review ratings.
Correlation of skill questions' scores, degree of difficulty, number employee review ratings.
Assessment of the amount of change in hiring criteria (and whether it falls within a pre-defined “normal window of operation”).
Post-hire evaluation of hiring criteria importance.
An intelligent agent increases the usefulness value of a skill question or group of skill questions, after a post-hire analysis where the question(s) were found to have a strong positive correlation with a key performance indicator or employee review rating.

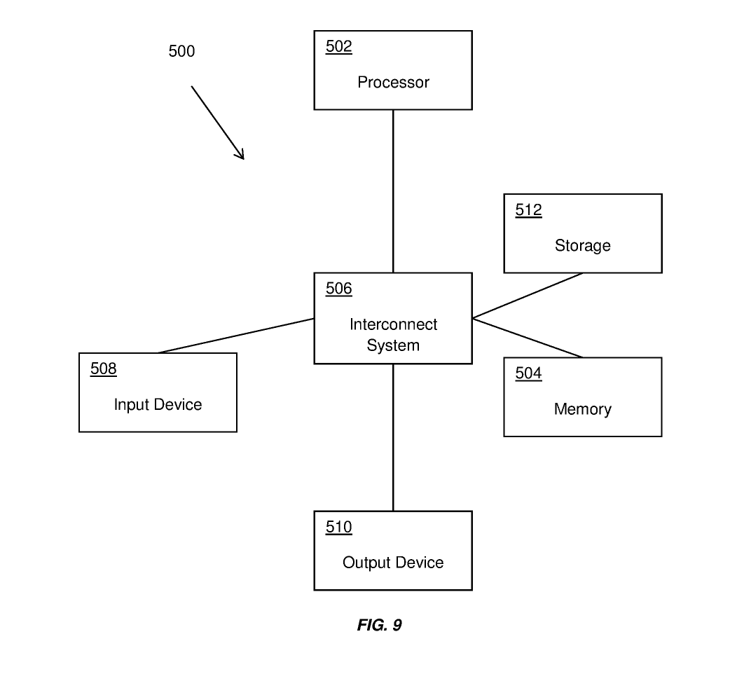

Various aspects and embodiments of systems and methods disclosed herein may involve specialized software executing in a general-purpose computer system 500 such as that shown in FIG. 9. The computer system 500 may include a processor 502 connected to one or more memory devices 504, such as a disk drive, solid state memory, or other non-transitory recording medium for storing data. Memory 504 is typically used for storing programs and data during operation of the computer system 500. Components of computer system 500 may be coupled by an interconnection mechanism 506, which may include one or more busses (e.g., between components that are integrated within a same machine) and/or a network (e.g., between components that reside on separate discrete machines). The interconnection mechanism 506 enables communications (e.g., data, instructions) to be exchanged between system components of system 500. Computer system 500 also includes one or more input devices 508, for example, a keyboard, mouse, trackball, microphone, touch screen, and one or more output devices 510, for example, a printing device, display screen, and/or speaker.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 500 is shown by way of example as one type of computer system upon which various aspects and embodiments disclosed herein may be practiced, it should be appreciated that aspects and implementations disclosed herein are not limited to being implemented on the computer system as shown in FIG. 9. Various aspects and implementations disclosed herein may be practiced on one or more computers having a different architecture or components than shown in FIG. 9.

Computer system 500 may be a general-purpose computer system that is programmable using a high-level computer programming language. Computer system 500 may be also implemented using specially programmed, special purpose hardware. In computer system 500, processor 502 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 500 may communicate with one or more other components over a wireless network, including, for example, a cellular telephone network.

It should be appreciated that the aspects and implementations disclosed herein are not limited to executing on any particular system or group of systems. Also, it should be appreciated that the aspects and implementations disclosed herein are not limited to any particular distributed architecture, network, or communication protocol. Various aspects and implementations disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example, ladder logic. Various aspects and implementations disclosed herein may be implemented in a non-programmed environment (e.g., documents created in HTML, XML or other format that, when viewed in a window of a browser program, render aspects of a graphical-user interface (GUI) or perform other functions). Various aspects and implementations s disclosed herein may be implemented as programmed or non-programmed elements, or any combination thereof.

Having thus described several aspects of at least one implementation, it is to be appreciated various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of providing decision support for personnel hiring, the method comprising:
receiving a list of one or more mandatory hiring criteria and one or more desirable hiring criteria for a position;
retrieving a profile of a job candidate from a candidate case base;
computing a suitability of the job candidate for the position by determining if the job candidate profile includes all mandatory hiring criteria, and responsive to the job candidate profile including all mandatory hiring criteria, computing a suitability ranking of the job candidate based on a degree of similarity of the one or more mandatory hiring criteria and one or more desirable hiring criteria to qualifications in the job candidate profile; and
ranking the job candidate against other job candidates based on the suitability ranking of the job candidate and suitability rankings of the other job candidates.

2. The method of claim 1, wherein the suitability of the job candidate for the position is calculated in accordance with the formula
$$SSC = \frac{{\sum }_{i = 1}^{N} {w}_{i} {s}_{i}}{{\sum }_{i = 1}^{N} {w}_{i}}$$
where:
i=1, . . . N are variables for N hiring criteria,
sᵢ is, for the i^{th} hiring criterion, a similarity of actual hiring criterion and corresponding employee qualification, and
wᵢ is a weight for the similarity of i^{th} variable.

3. The method of claim 2, wherein si for a hiring criterion is calculated in accordance with the formula
sᵢ=1−(jr^{min}−eqᵢ)/range(jrᵢ)
where:
jrᵢ is the i^{th} hiring criterion,
jrₘᵢₙ is a minimum acceptable value for jrⱼ, and
eqᵢ is an employee qualification corresponding to jrᵢ.

4. The method of claim 1, further comprising computing correlations of hiring criteria with business metrics.

5. The method of claim 1, further comprising assessing a change in mandatory and/or desired hiring criteria specified in hiring requests over time.

6. The method of claim 1, further comprising assessing importance of hiring criteria by changing a minimum acceptable value for a hiring criteria and determining a change in a number of high value employees that would have been selected for hiring if the hiring criteria included the changed minimum acceptable value.

7. The method of claim 1, further comprising assessing importance of hiring criterion as indicated by its correlation with a business metric.

8. The method of claim 1, further comprising performing a skill questions assessment based on how candidate scores, degree of difficulty, and number of questions correlate with employee review ratings.

9. The method of claim 1, further comprising assessing importance of hiring criteria by reclassifying a hiring criterion from desirable to mandatory and determining a change in a number of high value employees that would have been selected for hiring if the hiring criteria was mandatory.

10. A decision support system for personnel hiring comprising:
an employee case base including profiles of current employees;
an external candidate case base including profiles of external job applicants;
a rule engine including rules specifying hiring criteria for at least one position; and
an inference engine configured to search the employee case base and the external case base and to identify and present profiles of candidates having attributes showing correlations with attributes specified by a hiring manager for a position.

11. The system of claim 10, wherein the profiles of the current employees include data regarding the qualifications of the current employees and the profiles of the external job applicants include data regarding the qualifications of the external job applicants.

12. The system of claim 10, wherein the inference engine is further configured to search the employee case base and the external case base and to compute similarity of a candidate with an employee paradigm, the employee paradigm including an employee profile representing an ideal solution to a hiring need.

13. The system of claim 10, further comprising a hiring search case base including at least one hiring case representing hiring search criteria for a position.

14. The system of claim 13, wherein hiring cases in the hiring search case base include an indication of whether the hiring case is a hiring case for a strategic position.

15. The system of claim 13, wherein hiring cases in the hiring search case base include an indication of whether the hiring case is a hiring case for an unfilled position or for a filled position.

16. The system of claim 13, further comprising a user interface configured to receive a search query including a job description and to present a list of one or more hiring cases from the hiring search case base associated with the job description, the list generated by a hiring case search engine of the system.

17. The system of claim 16, wherein the user interface is further configured to receive an indication from a user whether a hiring case from the list of one or more hiring cases is useful to the user.

18. The system of claim 17, wherein the hiring search case base is configured to increase a usefulness rating of the hiring case responsive to the user providing the indication that the hiring case is useful.

19. The system of claim 18, wherein the hiring case search engine is configured to present the list of one or more hiring cases in the user interface ranked according to one or more of the usefulness ratings of the respective one or more hiring cases or creation dates of the respective one or more hiring cases.

20. The system of claim 13, further comprising a user interface configured to receive a search query including a job description and a job attribute and to present a list of one or more hiring cases from the hiring search case base associated with the job description and job attribute, the list generated by a hiring case search engine of the system.

21. The system of claim 10, further comprising an aggregate hiring search case base including all hiring criteria that have been specified in previous hiring searches for at least one job description.

22. The system of claim 21, wherein each skill question in the aggregate hiring search case base has an associated usefulness rating.

23. The system of claim 21, wherein each hiring criterion in the aggregate hiring search case base has an associated usefulness rating.

24. The system of claim 23, further comprising a user interface configured to receive an indication of a job description from a user and to display all hiring criteria in the aggregate hiring search case base associated with the job description to the user, the hiring criteria ordered according to one or more of the usefulness ratings of the respective hiring criteria or creation dates of the respective hiring criteria.

25. The system of claim 23, further comprising a user interface configured to receive an indication of a plurality of job descriptions from a user and to display all hiring criteria in the aggregate hiring search case base associated with the plurality of job descriptions to the user, the hiring criteria ordered according to one or more of the usefulness ratings of the respective hiring criteria or creation dates of the respective hiring criteria.

26. The system of claim 10, further comprising an intelligent agent including autonomous software configured to search for suitable candidates in the employee case base and/or external candidate case base as long as a hiring search remains open.

27. The system of claim 10, wherein the rules specifying the hiring criteria for the at least one position include a list of one or more mandatory qualifications and one or more preferable, but non-mandatory, qualifications.

28. The system of claim 10, further comprising a user interface configured to present a user with a menu of job descriptions, receive a selection of a job description from the user, present the user with a listing of qualifications, and receive an indication from the user of which qualifications in the list of qualifications are mandatory and which qualifications in the list of qualifications are optional for a hiring search.

29. The system of claim 28, further comprising functionality to provide for the user to add a job description to the menu of job descriptions.

30. The system of claim 28, further comprising functionality to provide for the user to add a qualification to the list of qualifications.

31. The system of claim 10, configured to perform the method of claim 1.
